(19) United States
(12) Patent Application Publication
(10) Pub. No.: US 2013/0086218 A1
(43) Pub. Date: Apr. 4, 2013

(54) Proxy Server For Home Network Access

(71) Applicants: Corey F. Adams, Frisco, TX (US); Michael J. Brehm, Allen, TX (US)

(72) Inventors: Corey F. Adams, Frisco, TX (US); Michael J. Brehm, Allen, TX (US)

(21) Appl. No.: 13/250,351

(22) Filed: Sep. 30, 2011

(51) Int. Cl. G06F 15/16

(52) U.S. Cl. 709/218

(57) ABSTRACT

A manner of extending a home network to a mobile device. A proxy server receives a request from a signaling gateway to transfer a communication session established between a home agent and a foreign agent. This may be done, for example, to accommodate an anticipated high-bandwidth transaction. If the proxy server has adequate resources available, it can accept the session. The agents provided with the address of the proxy server and independently send connection requests. The proxy server ensures that both agents are authenticated, and establishes secure communication tunnels. Traffic is then forwarded between the tunnels, in some cases after manipulation within the proxy server. Status messages may be multicast to inform signaling gateways or other entities of the resources available at the proxy server for this purpose.

### CROSS-REFERENCE TO RELATED APPLICATIONS

The present disclosure is related to and claims priority from U.S. patent application Ser. No. 12/985,730 entitled Method and Apparatus for Home Network Access and filed Mar. 23, 2010, which in turn claims priority to U.S. Provisional Patent Application Ser. No. 61/316,553, entitled Extending the In-Home Layer 2 Network and filed on 23 Mar. 2010 the entire contents of which Applications are incorporated in their entirety by reference herein. The present disclosure is also related to U.S. patent application Ser. No. 12/986,706 entitled Method and Apparatus for Home Networking Access Using a Remote Mobile Device and filed Jan. 7, 2011; U.S. patent application Ser. No. 13/077,633 entitled Method and Apparatus for Home Networking Access by a Trusted Monitoring Agent and filed Mar. 31, 2011; U.S. patent application Ser. No. 13/075,920 entitled Method and Apparatus for Enhancing QoS During Home Network Remote Access and filed Mar. 30, 2011; and U.S. patent application Ser. No. 13/173,961 entitled Method and Apparatus for Facilitating Home Network Access and filed Jun. 30 2011; the entire contents of which Applications are incorporated in their entirety by reference herein.

### TECHNICAL FIELD

The present invention relates generally to the field of communication networks, and, more particularly, to a proxy server or plurality of proxy servers for facilitating remote access by a subscriber to an in-home communication network.

### BACKGROUND

Introductory information will here be provided. Note, however, that the apparatus, techniques, or schemes described herein as existing or possible are presented only as background for describing the present invention, and no admission is intended thereby that these were heretofore commercialized or known to others beside the inventors.

Selected abbreviations are herewith defined, at least some of which are referred to within the following description of the state-of-the-art and the present invention.

### ASIC Application Specific Integrated Circuit

### BSS Business Support Systems

### CAC Call Admission Control

### CRL Certificate Revocation List

### DHCP Dynamic Host Configuration Protocol

### DSL Digital Subscriber Line

### DVR Digital Video Recorder

### HA Home Agent

### FA Foreign Agent

### IEEE Institute of Electrical and Electronics Engineers

### IP Internet Protocol

### ISP Internet Service Provider

### NAT Network Address Translation

### OS Operating System

### OSS Operations Support Systems

### PC Personal Computer

### PKI Public Key Infrastructure

### PS Proxy Server

### RG Residential Gateway

### SG Signaling Gateway

### QoS Quality of Service

### TCP Transmission Control Protocol

### UID Unique Identifier

Consumer electronics have progressed a great deal in the recent past. Not only are they more capable than they were a short time ago, they are also far more prevalent. Many homes, for example, have more than one personal computer and video storage device, along with many similar devices. These devices are often connected together to form a network, and through the network are capable of communicating with other devices outside of the home. The use of email and telephone services that are available through such networks is very common, and the downloading of, for example, software applications and multimedia transmissions is becoming more frequent.

A home network benefits users in a number of ways. Even if there is no connection to others outside of the home, the home network allows a user to, for example, print from a printer that is not connected directly to the computer in use. Files such as documents, pictures, and videos may be retrieved or sent to another device within the home. Modern data storage units are capable of saving a large amount of audio or video data, and the network permits this content to be retrieved and played on any device connected to the network. Multiple users may participate in a game over the network.

Connections outside of the home are often facilitated by some type of device that serves as an interface to whatever network service is providing access. Such a device may take the form, for example, of a wireless router connecting multiple computers to the Internet, or a set-top box that receives video and television programming for display on a television or other video display device. Many if not most home networks are connected to an access network, which provides a link between a subscriber's home and a core network capable of handling large amounts of communication traffic and providing gateways for communicating through other networks as well.

When the home network is connected to an access network, communications such as email and Internet access are permitted; video and audio content may be downloaded. In addition, recent advances in technology have enlarged the amount of data that may be uploaded, or sent from the home network to others through the access network. In some cases, for example a movie or other video may be sent to another at nearly the speed at which it was downloaded, at least from the user's perception.

This may be of great advantage to the user of a mobile device. As used herein, a mobile device is one capable of accessing a mobile network using radio communications. Mobile devices are very popular because of their mobility; a user may conveniently carry the device with them and use it anywhere a mobile network may be contacted. Mobile network providers have signed up thousands of subscribers and built up networks that cover large geographic areas. In many locations, if a subscriber cannot access their own mobile network, they may use another network as a visitor. Mobile networks are often based on a cell system, where mobile devices communicate with a nearby base station and handover protocols allow them to travel from one cell (base station) to another without significant interruption of an on-going communication session.

A mobile subscriber at home may be able to access content and devices that are part of the home network, for example using a short range radio protocol such as Bluetooth. When the user is not at home, however, such access is not available, but the content may be accessible in a number of other ways. For example, content accessible via the home network may not actually be stored there, but is rather stored in a remote memory device maintained by a vendor. In other cases the content may be stored within the home network, but is copied or mirrored at a vendor's server for the purpose of providing mobile access. In either case, the user may access the content being stored by the vendor using a mobile device communicating though a mobile network.

There are disadvantages with this strategy, however. For one, storage on a vendor site may raise security concerns. In addition, the vendor may charge for the service and there is a risk that they may at some point become unavailable if their business fails. Finally, the sheer volume of content that users currently want to, and are projected to demand, may make this option less than viable in the future.

Access may also be possible directly to the home network though a mobile network using protocols such as MobileIP. In such an arrangement it is contemplated that the mobile device embodies a foreign agent (FA) that establishes a communication session with a home agent (HA) embodied on one of the devices that makes up the home network. Although this addresses some of the disadvantages associated with third party vendors, several disadvantages remain.

First, to communicate with the FA, the HA obtains an IP address. In general practice, however, this IP address will be dynamically assigned, meaning that he address is not assigned permanently but will eventually be re-assigned to another user. Of course, the HA can request another IP address, but when assigned it will almost certainly be different than the previous one. While the policy of dynamically assigning IP addresses conserves IP addresses and reduces the number ultimately required, it can disrupt routing between the FA and the HA and make it more difficult for the mobile device to register with its respective HA.

In addition, home networks frequently employ a residential gateway, with the HA being assigned a private IP address and being behind a NAT boundary. This also may help to conserve IP addresses, but may make it difficult for the FA to contact the HA and set up a secure tunnel for communications. Other problems may also arise, especially for long duration or high bandwidth transmissions between a home network devise and a mobile device. As this will generally involve at least two separate networks, capacity, encryption, or protocol differences may hinder transmission even where a connection is possible.

In the face of such difficulties, there is a need for a manner of facilitating secure access to a home network from a remote mobile station. Accordingly, there has been and still is a need to address the aforementioned shortcomings and other shortcomings associated with communications between a FA embodied in a mobile device and an HA in a home network. These needs and other needs are satisfied by the present invention.

### SUMMARY

The present invention is directed to a manner of facilitating access to a home network by a mobile device. In one aspect, the present invention is a method of providing remote access via a PS (proxy server) for a mobile device comprising an FA (foreign agent) to a home network comprising an HA (home agent), including receiving a transfer request from an SG at the PS, responding to the request from the SG, receiving a connection request from an HA, establishing a first tunnel between the PS and the HA, receiving a connection request from an FA, establishing a second tunnel between the PS and the FA, and enabling a communication session between the HA and the FA. The communication session may be establishing by setting up a direct link in the PS to route traffic between the first tunnel and the second tunnel, or by buffing the traffic before forwarding traffic received from one agent to the other. Manipulating the received data traffic prior to forwarding may include encrypting or decrypting the traffic, or both, or formatting the data traffic in accordance with a different protocol. It may also include encoding the data traffic at a different rate that the rate at which it was received.

The method may also entering the HA-FA pair into an FA-HA table at the PS so that requests from agents not listed there may be rejected or ignored, and to check to so that both agents are present before initiating the communication session. If one agent request is received but the other, a hold message may be generated for transmission to the requesting agent so that a heartbeat can be initiated to maintain the tunnel until the second agent request is received.

The method may also include generating a status message, for example when a communication session is initiated or terminated. The generated status message may be sent to an SG, or multicast to a number of SGs or other entities, to provide an indication of what resources are in use or available at the PS.

In another aspect, the present invention is a A PS including a processor, memory device accessible to the processor, and an HA-FA pair table for listing an HA-FA communication pair during a communication session. The PS may also include a status message generator configured for generating a status message for multicasting to SGs. In some embodiments, the PS also includes a data manipulator for manipulating data traffic in a communication session between an HA and an FA, a data traffic buffer for buffering data traffic prior to manipulating the data traffic by the data manipulator, and a data manipulating rules database for us in manipulating the data traffic by the data manipulator.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be obtained by reference to the following detailed description when taken in conjunction with the accompanying drawings wherein:

FIG. 1 is a simplified schematic diagram illustrating selected components of a home network according to an embodiment of the invention;

FIG. 2 is a simplified schematic diagram illustrating selected components of a communication network according to an embodiment of the present invention;

FIG. 3 is a flow diagram illustrating a method according to an embodiment of the present invention;

FIG. 4 is a flow diagram illustrating a method according to an embodiment of the present invention;

FIG. 5 is a flow diagram illustrating a method according to an embodiment of the present invention; and

FIG. 6 is a simplified schematic diagram illustrating selected components of a PS according to an embodiment of the present invention.

### DETAILED DESCRIPTION

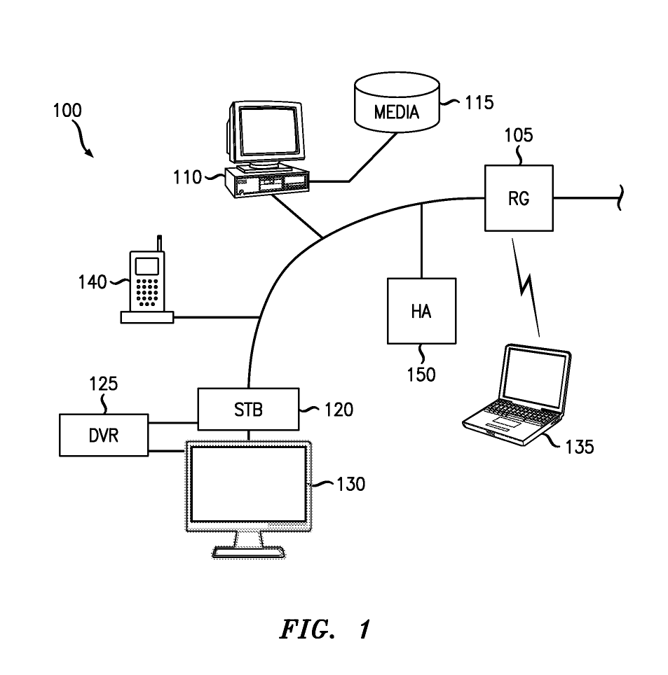

The present invention is directed to a manner of extending a home network to a remote mobile device, and is of particular advantage when implemented in an environment where communication with the home network is limited by a dynamic connection point to the Internet and a NAT (network address translation) boundary FIG. 1 is a simplified schematic diagram illustrating selected components of a home network 100 according to an embodiment of the invention. Note that the home network is so-called because the components used are suitable to acquisition and use in-home by a subscriber, but the same system could just as easily be installed in, for example, a small business, school, or church office setting. For convenience, such a network will be referred to as a home network regardless of whether it is installed in the residence of a single subscriber or in another location.

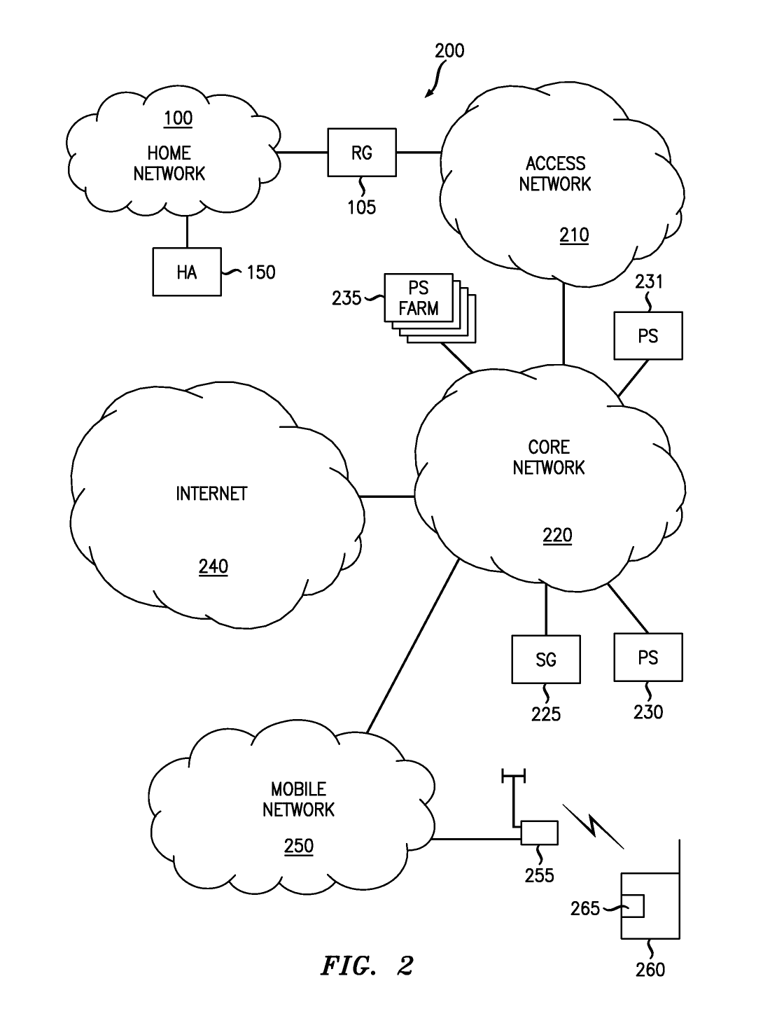

The various components of a home network could be limited to communication only among themselves—within the home (or other installed location), but this is typically not the case. Communication with outside devices is often one of the reasons for which the home network was established. In the embodiment of FIG. 1, home network 100 includes an RG (residential gateway) 105. RG 105 facilitates communications between home network 100 and an access network (not shown in FIG. 1). The access network in turn provides a conduit to a core communication network and then to other networks and devices (see, for example, FIG. 2).

In the embodiment of FIG. 1, RG 105 may also act as a router to receive communications from outside and transmit them to the various components of network 100. In this embodiment, these components include a PC 110 and associated media storage device 115. Telephone service is also available through home network 100, as represented by telephone 140. A set-top box 120 is also part of home network 100 and is associated with DVR 125. In this embodiment, network 100 also includes a telephone 130 and laptop computer 135. As indicated in FIG. 1, many components of network 100 are connected by a cable to RG 105, while the laptop 135 uses a wireless interface. Of course, this particular combination of components, while not uncommon, is exemplary and other home networks may be configured differently.

In accordance with the present invention, home network 100 also includes an HA (home agent) 150, which has several functions that are described in more detail in U.S. patent application Ser. No. 12/985,730, referred to above. HA 150 is typically implemented as a physical processor executing instructions stored as software in a non-transitory medium. In other embodiments, the HA may be implemented as a combination of executable software and hardware such as an ASIC. The HA may be a standalone device or incorporated in a multifunction apparatus that performs other duties as well. In some implementations it may, for example, be implemented in RG 105 or PC 110.

In accordance with this embodiment of the present invention, the HA 150 acquires a UID (unique identifier) that may be used for communications sessions involving FAs authorized to access the home network. There are several ways in which this acquisition could be made; in one embodiment the HA simply generates its own UID, for example using the serial number of the processor. In another embodiment, the HA uses a UID from the OS (operating system). In either case, the UID acquisition scheme should insure the uniqueness of the UID. The UID may also be generated by another element, for example, one could be assigned when registering with an SG (signaling gateway; see for example FIG. 2). If generated by another element, the HA would preferably store it in encrypted form in an accessible memory device.

FIG. 2 is a simplified schematic diagram illustrating selected components of a communication network 200 according to an embodiment of the present invention. Note that communication network 200 actually includes several networks (or, more accurately, components within those networks, which components are not shown separately). For example, home network 100 is illustrated as a cloud (although it is shown in more detail in FIG. 1), except that HA 150 is also depicted in FIG. 2, as is RG 105. RG 105 connects the home network 100 to access network 210. Access network may, for example, be a DSL implementation in a PSTN or a PON (passive optical network). Access network 210 in turns provides a connection to core network 220. In general, core network 220 is a large capacity packet data network that routes communications between many different entities, including home network 100 via access network 210.

In this embodiment, for example, the core network 220 is in communication with the Internet 240, providing home network 100 with Internet access. Again, there may be one or more gateway devices used at the interface, though for simplicity these components are not shown individually in FIG. 2. Separately shown, however, are a signaling gateway (SG) 225, proxy servers (PS) 230 and 231, and a proxy server farm (PS Farm) 235. SG 225 and PS 230 are typically implemented as a physical processor executing instructions stored as software in a non-transitory medium. In other embodiments, the SG and the PS may be implemented as a combination of executable software and hardware such as an ASIC. Each (or both) of these devices could be software executing on a single physical unit or could be implemented using multiple physical devices working cooperatively. The operation of these components in accordance with the present invention will be described below.

In the embodiment of FIG. 2, core network 220 is also connected to mobile network 250. Mobile network 250 typically includes a number of geographically dispersed base stations, each with their own antenna, for communicating with mobile devices in their local area. Antenna/base station 255 is depicted for purposes of illustration. Antenna/base station 255 may include, for example, an eNodeB. Mobile device 260 is also shown and is capable of radio communications with antenna/base station 255 to set up a communication session through mobile network 250. Although only one is shown, a mobile network ordinarily includes a large number of antenna/base stations and employs a protocol for handing over a communication session from one antenna/base station to another when the mobile device relocates.

In this embodiment of the present invention, mobile device 260 includes a FA (foreign agent) 265, which may register with HA 150 in order to access home network 100. The FA is described in more detail in U.S. patent application Ser. No. 12/986,706, referred to above. In accordance with the present invention a secure communication path, or tunnel, is established between FA 265 of mobile device 260 and HA 150 of home network 100 though SG 225. The SG, however, is expected to handle only low-bandwidth communications. If the SG becomes over-loaded or determines that a particular communication session will be high bandwidth, then it will attempt to transfer the communication session to a PS in communication with the communications network. This process will be described in more detail below.

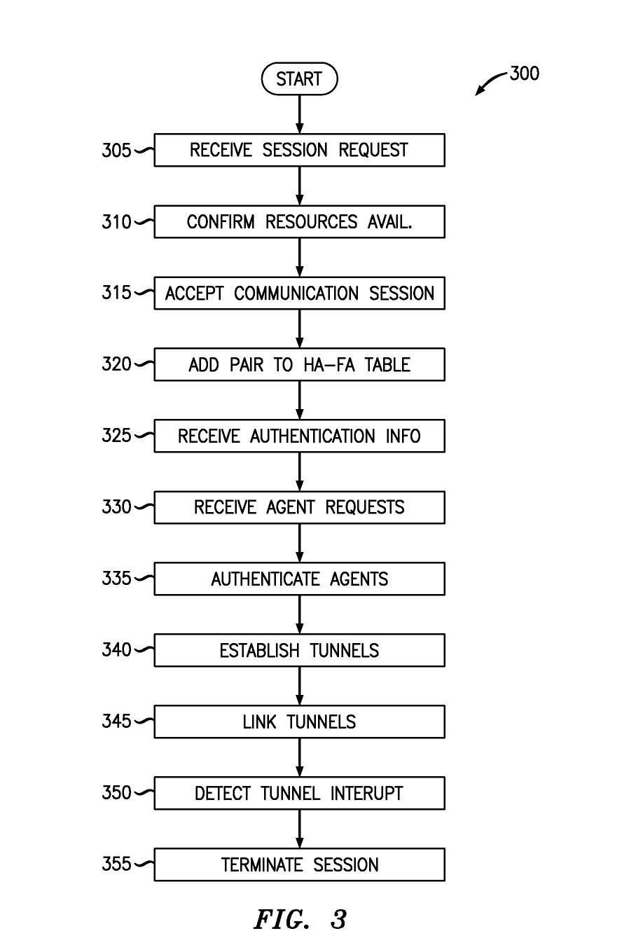

FIG. 3 is a flow diagram illustrating a method 300 according to an embodiment of the present invention. At START it is presumed that the components necessary to performing the method are available and operational according to the embodiment of method 300. The process then begins when a PS receives session request from an SG (step 305). In this embodiment, the session request is presumed to include at least an HA UID, an FA UID, and a bandwidth estimate for the communication session. The PS then confirms that it has the resources available to handle the session (step 310). If this proves not to be the case, of course, the PS cannot assume the communication session for the SG. In some implementations, however, the SG maintains a list of PS availability, in which case such rejections should be infrequent.

PS farms may also be utilized so that if the necessary resources are not available at the PS contacted by the SG, the request may be passed (not shown) to associated PSs in the PS farm. This may be done through communication among the PSs, or the contacted PS may just inform the SG of the address of another PS. The PS farm may also have a communication center for responding to SGs and then allocating the accepted sessions to available PSs within the PS farm.

In the embodiment of FIG. 3, if the PS confirms resource availability, it responds (step 315) to the SG accepting the communication session and stores (step 320) the agent identities on an HA-FA pair table at the PS. The PS then receives authentication information and certificates (step 325) from the SG as will be necessary to assume the communication session. In this embodiment, it is presumed that the SG will provide the address off the PS to the FA and the HA, which will initiate contact with the PS (not shown). When the PS receives the agent requests (step 330) from the HA and the FA, the agents are then authenticated (step 335) using the authentication information provided by the SG to the PS in step 320.

In this embodiment, once an agent has been authenticated, a tunnel is established (step 340) for secure communication between the PS and each agent. According to the present invention, each agent establishes a separate tunnel and is therefore communicating directly with the PS. When tunnels to both the FA and the HA have been established, the PS links (step 345) the two tunnels by routing packets from one to the other. The communication session then continues until one of the agents terminates its tunnel to the PS. This, of course may happen intentionally or inadvertently. Whenever the PS detects (step 350) that one or both of the agents has interrupted their connection, then the communication session is terminated (step 355) by the PS. In this embodiment, even if the termination was inadvertent, the agents will still be required to re-establish contact with an SG before their session can resume.

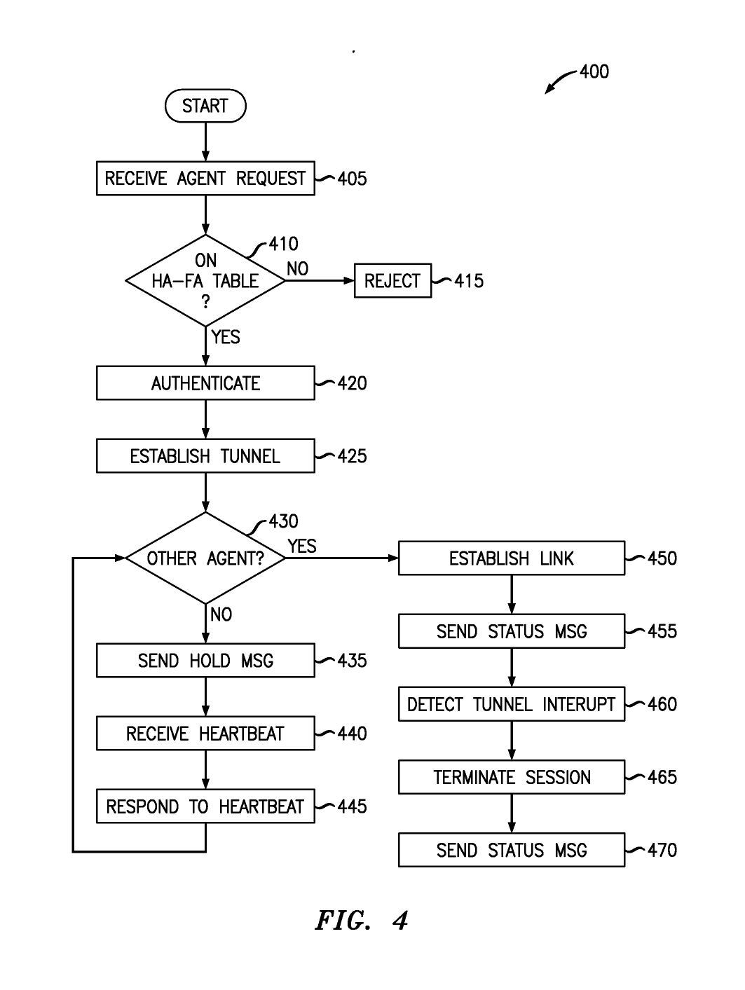

FIG. 4 is a flow diagram illustrating a method 400 according to an embodiment of the present invention. At START it is presumed that the components necessary to performing the method are available and operational according the embodiment of method 400. The process then begins when the PS receives a request (step 405) from an agent to establish a connection to the PS. The agent may be ether an HA or an FA. The PS then determines (step 410) whether and HA-FA pair is listed on the HA-FA pair table of the PS. If the agent is not listed, the PS generates a rejection message (step 415) for transmitting to the agent. If the agent is listed in the HA-FA table, the agent is then authenticated (step 420) and a tunnel to the agent is established (step 425).

In this embodiment, the PS then determines (step 430) whether a connection request has been received from the other agent of the HA-FA pair (step). If a connection request has been received from one agent of the HA-FA pair but not from the other, a hold message is generated (step 435) for transmission to the agent from whom the connection request was received. The communication session cannot begin, of course, until the other agent of the HA-FA pair has also contacted the PS.

In the embodiment of FIG. 4, when an agent has received a hold message and a tunnel to the PS has been established, the agent will seek to maintain the tunnel by initiating a periodic heartbeat message (not shown). When the PS receives (step 440) a heartbeat message from the agent, it generates a response (step 445) for transmission in reply. In this way, the tunnel is not closed for lack of activity. If for some reason, however, a heartbeat message is not received from the agent, the PS may close the tunnel of its own initiative (not shown).

In the embodiment of FIG. 4, when the PS responds to an agent heartbeat request at step 445 it also returns to step 430 and determines whether a connection request has been received from the other agent of the HA-FA pair. If both agents of the HA-FA pair have been authenticated with the PS and separate tunnels established, then a link is established (step 450) between the tunnels and the communication session may commence.

In this embodiment, when the communication session commences, a status message is generated (step 455) for multicasting to SGs on an SG table of the PS. In this way each SG receiving the message may record that the session has started (not shown). This enables not only tracking of the communication session, but also that certain resources of the PS have been committed. If an SG tracks resource usage for PSs that are listed on its PS table, then it may select for transferring communication sessions those PSs able to handle the assignment.

In the embodiment of FIG. 4, the communication session continues until the PS detects (step 460) that one or both agents have interrupted their tunnel connection to the PS. When this occurs, the communication session is terminated (step 465), and a status message is generated (step 470) for multicasting to SGs on the SG table of the PS. Note that the status messages generated by the PS may be transmitted elsewhere, for example an OSS/BSS associated with the communication network. The messages may also be generated more frequently to report the status of on-going sessions.

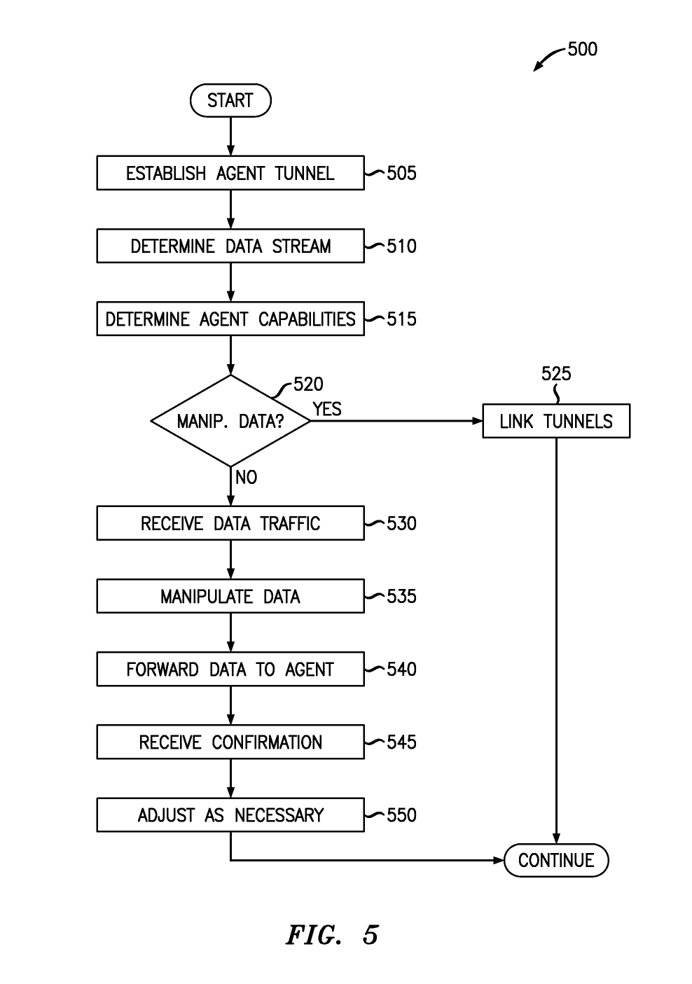

FIG. 5 is a flow diagram illustrating a method 500 according to an embodiment of the present invention. At START it is presumed that the components necessary to performing the method are available and operational according to the embodiment of method 500. The process then begins when a PS establishes a tunnel connection (step 505) to at least one of the agents The PS then determines the character of the anticipated data stream (step 510). In a preferred embodiment, the SG will have reported this information when the initial session transfer was negotiated, but alternately it could be determined from the connected agent. In similar fashion, the PS also determines the capabilities of each agent in the HA-FA agent pair (step 515).

In accordance with the present invention, character of the data stream and the capabilities of the respective agents may be pertinent to facilitating the communication session. For example, an HA may be operating under an IPv6 protocol, while a given mobile device having an FA may only be able to accommodate IPv4. The two agents may or may not support encryption or may use different encryption schemes, but the character of the data stream is such that encryption is desirable. For another example, a home agent may be capable of streaming data from a device on the home network at a much faster rate than the mobile network or mobile device is able to receive. Other communication session mismatches may also be discovered at steps 510 and 515.

In the embodiment of FIG. 5, the PS then uses this information to determine if data stream manipulation is required (step 520). Naturally, in some cases after making the inquiries of steps 510 an 515, it may be determined at step 520 that no manipulation is necessary. In this case, the communication session link may be established by the PS (step 525), which simply routes data traffic from one tunnel to the other. Note this presumes that both agents in the HA-FA pair have established connections to the PS. If this is not the case, the PS may resort to the procedure described above in reference to FIG. 4, sending a hold message and responding to agent heartbeats until both tunnels are established.

In the embodiment of FIG. 5, if it is determined at step 520 that data stream manipulation is required, then the communication session is initiated and data traffic is received and buffered in a PS traffic buffer (step 530). From the buffer the data traffic may be removed and the necessary data manipulation is performed (step 535). Again, this may include encrypting or decrypting the data, altering to be compatible with a different protocol, or simply encoding it at a slower or faster rate. The manipulated data is then forwarded (step 540) toward the intended recipient agent over the established tunnel.

In this embodiment, the PS then may receive (step 545) a confirmation message from the recipient agent. This is not required in all implementations, and preferably if none is received the communication session is unaffected. In this embodiment, the confirmation message includes an indication that the data stream is (or is not) being satisfactorily received. The PS in response makes any necessary corrections to the data manipulation (step 550). Although not shown in FIG. 5, more than one confirmation message may be received by the PS during the communication session. The process then continues with the PS facilitating the communication session until it is terminated.

Note that the sequences of operation presented above in reference to FIGS. 3 through 5 are exemplary, and the present invention is not limited to the illustrated embodiments. Additional operations may be added, or in some cases removed, without departing from the spirit of the invention. In additional the operations of the illustrated methods may be performed in any logically-consistent order unless a contrary requirement is recited in a particular embodiment.

Here it is also noted that, for example in the case of content streaming, more than one FA may receive the transmission from a home device. In that case the above-described methods would be modified accordingly. For example the multiple FAs would be reflected in the HA-FA pair table, and the PS would wait until tunnels to all of the FAs listed are established before initiating the communication session by linking the relevant tunnels (unless a contrary preference is implemented).

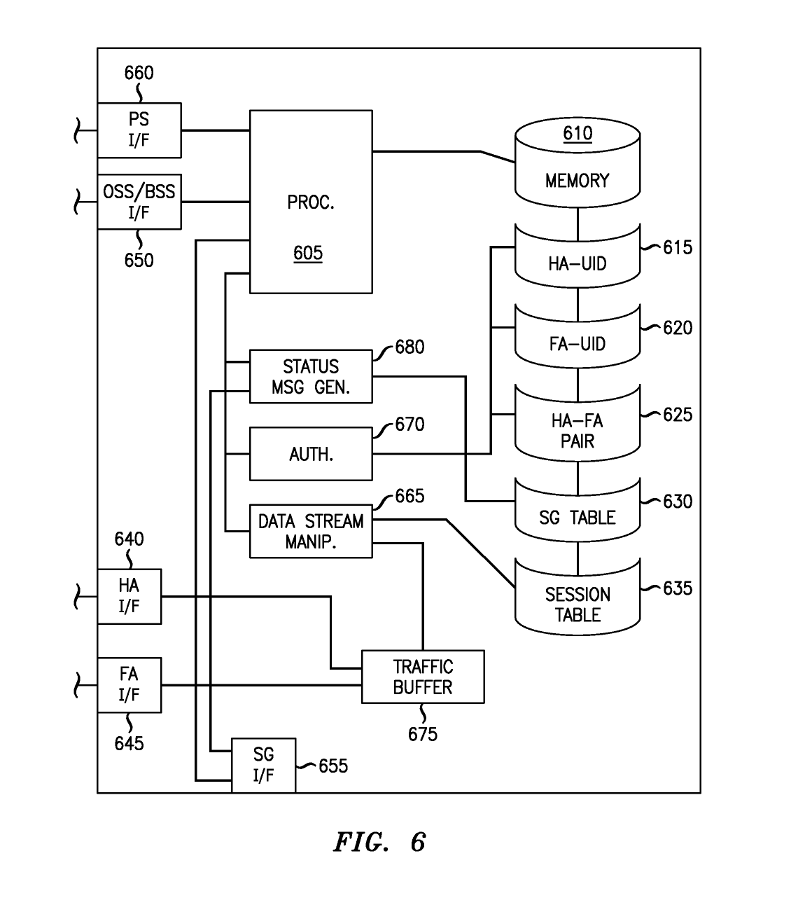

FIG. 6 is a simplified schematic diagram illustrating selected components of a PS 600 according to an embodiment of the present invention. In this embodiment, the PS 600 includes a processor 605 for controlling the other components of PS 600 and a memory device 610, which stores both data and program instructions for controlling the PS 600. Memory device, as used herein, connotes a physical, non-transitory apparatus. Authentication module 670, which may be implemented in hardware or as software executing on hardware, handles authentication of HAs and FAs prior to initiating a communication session.

Shown separately in FIG. 6 are an HA-to-UID mapping table 615 and an FA-to-UID mapping table for storing the identity of each HA and FA that has been received from an SG when transferring a communication session to the PS. An FA-to-HA pair table 625 tracks the anticipated and occurring communication sessions that have been or are expected to be established. Also shown in FIG. 6 is SG table 630 that indicates those SGs that may be contacting the PS 600 to transfer communication sessions. Any necessary identification or authentication information that may be required in that circumstance is stored as well. Communication session table 635 maintains any received characteristics of the data stream associated with a communication session or of the HA and the FA involved.

Also depicted in FIG. 6 is a dedicated home network interface 640 though which the PS 600 will communicate with HAs and a mobile network interface 645 for communication with mobile FAs. In a preferred embodiment, separate interfaces are provided to accommodate, for example, different versions of IP. Also shown separately is an OSS/BSS interface 650 though which communication with the OSS/BSS may be handled via a communication network. An SG interface 655 is for communicating with SG attached to the network and a PS interface 660 handles communication with one or more PSs if it is necessary, for example among the PSs in a PS farm to balance traffic loads or transfer communication sessions.

In the embodiment of FIG. 6, also depicted is a status message generator 680 for generating status messages to be sent to the SGs of the network and elsewhere, as applicable. Data stream manipulator 665 is available for performing any traffic manipulation with respect to data stored in traffic buffer 675.

The components depicted in FIG. 6 are exemplary; in other embodiments there may be more or fewer, and some of those shown may be combined with each other. All components of SG 600 are implemented in hardware or software executing on a hardware platform.

In this manner the present invention facilitates access to a home network using an HA by a remote mobile device having an FA registered with the HA. Secure tunnels may be established between the FA and HA and a PS, usually after transfer of a communication session from an SG. The communication session may then be handled by the PS until it is terminated.

In this manner the present invention facilitates access to a home network using an HA by a remote mobile device having an FA registered with the HA. A secure tunnel may be established between the FA and a PS, and linked with a secure tunnel between the HA and the PS.

Although multiple embodiments of the present invention have been illustrated in the accompanying Drawings and described in the foregoing Detailed Description, it should be understood that the present invention is not limited to the disclosed embodiments, but is capable of numerous rearrangements, modifications and substitutions without departing from the invention as set forth and defined by the following claims.

1. A method of providing remote access via a PS (proxy server) for a mobile device comprising an FA (foreign agent) to a home network comprising an HA (home agent), said method comprising:
receiving a transfer request from an SG at the PS;
responding to the request from the SG;
receiving a connection request from an HA;
establishing a first tunnel between the PS and the HA;
receiving a connection request from an FA;
establishing a second tunnel between the PS and the FA; and
enabling a communication session between the HA and the FA.

2. The method of claim 1, wherein establishing a communication session between the HA and the FA comprises routing traffic between the first tunnel and the second tunnel.

3. The method of claim 1, wherein establishing a communication session between the HA and the FA comprises buffering data traffic received from one of the HA and the FA in a buffer of the PS before forwarding the data traffic to the other one of the HA and the FA.

4. The method of claim 3, further comprising manipulating the received data traffic prior to forwarding.

5. The method of claim 4, wherein manipulating the data traffic comprises decrypting the data traffic.

6. The method of claim 4, wherein manipulating the data traffic comprises encrypting the data traffic.

7. The method of claim 4, wherein manipulating the data traffic comprises formatting the data traffic for a protocol different from the protocol the received data traffic is formatted for.

8. The method of claim 4, wherein manipulating the data traffic comprises encoding the data traffic at a different rate that the rate at which it was received.

9. The method of claim 1, further comprising detecting an interruption in at least one of the first tunnel and the second tunnel and terminating the communication session.

10. The method of claim 1, further comprising entering the HA-FA pair into an FA-HA table at the PS.

11. The method of claim 10, further comprising, prior to establishing a tunnel between the PS and the agent, determining if the agent is entered in the HA-FA table.

12. The method of claim 11, further comprising, subsequent to receiving a connection request from an agent, determining if a connection request has been received from the other agent in the HA-FA pair.

13. The method of claim 12, further comprising, if a connection request has not been received from the other agent in the HA-FA pair, generating a hold message for transmission to the agent requesting the connection.

14. The method of claim 13, further comprising:
receiving a heartbeat message from the requesting agent at the PS; and
responding to the heartbeat message.

15. The method of claim 1, further comprising, subsequent to receiving a connection request from an agent, executing an authentication protocol prior to establishing a tunnel between the PS and the agent.

16. A PS (proxy server), comprising:
a processor;
a memory device accessible to the processor; and
an HA-FA pair table for listing an HA-FA communication pair during a communication session.

17. The PS of claim 16, further comprising a status message generator configured for generating a status message for multicasting to SGs.

18. The PS of claim 16, further comprising a data manipulator for manipulating data traffic in a communication session between an HA and an FA.

19. The PS of claim 18, further comprising a data traffic buffer for buffering data traffic prior to manipulating the data traffic by the data manipulator.

20. The PS of claim 16, further comprising a data manipulating rules database for us in manipulating the data traffic by the data manipulator.
